(19) United States
(12) Patent Application Publication
(10) Pub. No.: US 2013/0024313 A1
(43) Pub. Date: Jan. 24, 2013

(54) COMMERCE NETWORK FOR MATCHING BUYERS AND SELLERS

(71) Applicant: Ariba, Inc., Sunnyvale, CA (US)

(72) Inventors: Kshitij Dayal, San Jose, CA (US); Robert Mihalko, Los Altos, CA (US); Sudhir Bhojwani, Mountain View, CA (US)

(73) Assignee: ARIBA, INC., Sunnyvale, CA (US)

(21) Appl. No.: 13/632,031

(22) Filed: Sep. 30, 2012

Related U.S. Application Data
(63) Continuation-in-part of application No. 13/270,189, filed on Oct. 10, 2011.
Application No. 13/270,189 is a continuation-in-part of application No. 13/176,020, filed on Jul. 5, 2011.
(60) Provisional application No. 61/488,744, filed on May 22, 2011.

(51) Int. Cl. G06Q 30/00

(52) U.S. Cl. 705/26.2

(57) ABSTRACT

Embodiments for methods, systems and apparatuses of a commerce network for matching buyers and sellers are disclosed. One computer-method includes identifying buyer information, wherein the buyer information includes at least one of a buyer need or a buyer profile, wherein the buyer need includes at least one of a commodity or service that the buyer has indicated a present need, and wherein the buyer profile includes at least self-reported information. The computer-method further includes identifying seller information, wherein the seller information includes at least one of a seller profile and tracked seller behavior, wherein the seller profile includes at least self-reported information and wherein the tracked seller behavior includes at least interest shown or responses of a seller to previously identified instances of buyer information. The computer-method further includes matching the buyers with sellers by matching the buyer information with the seller information.

### RELATED APPLICATIONS

This patent application is a continuation-in-part (CIP) of U.S. patent application Ser. No. 13/270,189, filed Oct. 10, 2011, which is a continuation-in-part (CIP) of U.S. patent application Ser. No. 13/176,020, filed Jul. 5, 2011, which claims priority to U.S. Provisional Patent Application No. 61/488,744 filed on May 22, 2011, which are all herein incorporated by reference.

### FIELD OF THE DESCRIBED EMBODIMENTS

The described embodiments relate generally to a supplier/buyer commerce network. More particularly, the described embodiments relate to a methods, apparatuses and systems for a commerce network for matching buyers and sellers.

### BACKGROUND

Commerce networks provide a means for electronically connecting buyers and suppliers. Buyers can enhance their supplier network by being electronically connected to many different suppliers. As a result, a buyer may be able to obtain better selection and pricing, and the suppliers may be able to realize additional sales.

Suppliers would like to provide information that describes the supplier capabilities online. Additionally, suppliers want to port their offline (brick-and-mortar) reputations, references, and provide potential new customers with the ability to interact with them further.

There is a need for systems, methods and apparatuses for a commerce network that matches buyers and sellers.

### SUMMARY

An embodiment includes a computer-method of a commerce network for matching buyers and sellers. The computer-method includes identifying buyer information, wherein the buyer information includes at least one of a buyer need or a buyer profile, wherein the buyer need includes at least one of a commodity or service that the buyer has indicated a present need, and wherein the buyer profile includes at least self-reported information. The computer-method further includes identifying seller information, wherein the seller information includes at least one of a seller profile and tracked seller behavior, wherein the seller profile includes at least self-reported information and wherein the tracked seller behavior includes at least interest shown or responses of a seller to previously identified instances of buyer information. The computer-method further includes matching the buyers with sellers by matching the buyer information with the seller information.

Another embodiment includes a commerce network for matching sellers with a buyer. The commerce network includes at least one commerce network server connected through a network to buyer servers and seller servers. The at least one commerce network server is operative to identify buyer information, wherein the buyer information includes at least one of a buyer need or a buyer profile, wherein the buyer need includes at least one of a commodity or service that the buyer has indicated a present need, and wherein the buyer profile includes at least self-reported information. The at least one commerce network server is further operative to identify seller information, wherein the seller information includes at least one of a seller profile and tracked seller behavior, wherein the seller profile includes at least self-reported information and wherein the tracked seller behavior includes at least interest shown or responses of a seller to previously identified instances of buyer information. The at least one commerce network server is further operative to match the buyer with one or more sellers by matching the buyer information with the seller information.

Another embodiment includes a program storage device readable by a machine, tangibly embodying a program of instructions executable by the machine to perform a computer-method of a commerce network for matching buyers and sellers. The computer-method includes identifying buyer information, wherein the buyer information includes at least one of a buyer need or a buyer profile, wherein the buyer need includes at least one of a commodity or service that the buyer has indicated a present need, and wherein the buyer profile includes at least self-reported information. The computer-method further includes identifying seller information, wherein the seller information includes at least one of a seller profile and tracked seller behavior, wherein the seller profile includes at least self-reported information and wherein the tracked seller behavior includes at least interest shown or responses of a seller to previously identified instances of buyer information. The computer-method further includes matching the buyers with sellers by matching the buyer information with the seller information.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a system that facilitates matching buyers and sellers, according to an embodiment.

FIG. 2 shows is a block diagram that functionally shows a buyer being matched with one or more suppliers, according to an embodiment.

FIG. 3 shows is a block diagram that functionally shows a buyer being matched with one or more suppliers driven by broadly matching buyer and seller information, according to another embodiment.

FIG. 4 is a flow chart that includes steps of a computer-method of a commerce network for matching buyers and sellers, according to an embodiment.

FIG. 5 illustrates storing and logging buyer history information according to an embodiment.

FIG. 6 shows a schematic illustration of one embodiment of a computer system that can perform the methods of the described embodiment, and/or can function as, for example, a supplier/buyer commerce network that electronically matches buyers and suppliers.

### DETAILED DESCRIPTION

The embodiments described include methods, systems and apparatuses for a supplier/buyer commerce network electronically matching buyers and suppliers (that is, suppliers to buyers and/or buyers to suppliers). The embodiments expand the number of suppliers available to the buyer, and therefore, allow the buyer to obtain more favorable terms and broader selection. In addition, this allows sellers to market themselves to prospective buyers, and therefore expand their customer base.

The terms “supplier” and “seller” may be used interchangeably in the disclosure.

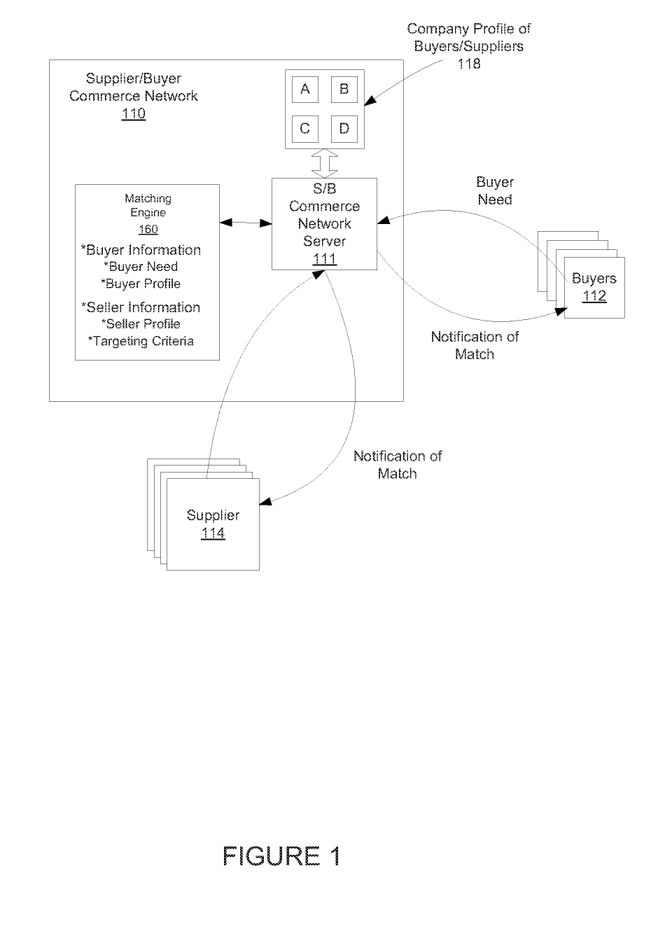

FIG. 1 shows a system that facilitates matching buyers and sellers, according to an embodiment. A supplier/buyer network 110 includes a commerce network server 111 that manages matching of buyers 112 with suppliers 114 as performed by a matching engine 160. The supplier/buyer network 110 further manages company profiles of the buyers and the sellers.

The matching engine 160 matches the buyers and sellers using buyer information and supplier information. The matching engine 160 is shown as being separate from the commerce network server 111. For at least some embodiments, the matching engine 160 and the commerce network server 111 are included on a single server. For other embodiments, the matching engine 160 and the commerce network server 111 are included over multiple servers.

An embodiment includes identifying buyer information, by the commerce network server 111, wherein the buyer information includes at least one of a buyer need or a buyer profile. For an embodiment, the buyer need includes at least one of a good or service that the buyer has indicated a present need. The terms good and service can be generally designated as a commodity. For an embodiment, the buyer profile includes at least self-reported information.

An embodiment includes identifying seller information, by the commerce network server 111, wherein the seller information includes at least one of a seller profile and tracked seller behavior. For an embodiment, the seller profile includes at least self-reported information. For an embodiment, the tracked seller behavior includes at least interest shown or responses of a seller to previously identified instances of buyer information.

Embodiments of the buyers 112 and the supplier 114 are enterprise networks that include enterprise servers. The enterprise servers of the buyers 112 and the supplier 114 are network connected (through, example, the internet) to the supplier/buyer commerce network 110. The supplier/buyer commerce network 110 can include one or more servers (such as, S/B commerce network server 111) that support the described embodiments for electronically matching buyers and suppliers. Embodiments of each of the servers include processors.

The buyers 112 are typically associated with the supplier/buyer commerce network 110 in some capacity. However, suppliers 114 are not so limited. That is, the suppliers 114 can be either associated (enabled) or not associated (not enabled) with the supplier/buyer commerce network 110. A first type of supplier 114 is associated with the supplier/buyer commerce network 110, while a second type of supplier 114 is not directly associated with the supplier/buyer commerce network 110, but can be reached through other networks (through, for example, the internet), social media, direct marketing, etc.

For embodiments, the company profile includes at least four quadrants that include at least a first quadrant (A) that includes self-reported information, a second quadrant (B) that includes community information, a third quadrant (C) that includes third party information, and a fourth quadrant (D) that includes aggregated activity information. It is to be understood that for some embodiments the company profile can include a subset of these quadrants, and for other embodiments, the company profile can include information in addition to the information of these four quadrants. The company profile 118 is a collection of information pertaining to the corresponding company that is associated with the network. The company profile allows other companies (suppliers 114 and/or buyers 112) to evaluate the company associated with the company profile 118. Clearly, the company profile can include fewer or more than the four quadrants.

For an embodiment, a match is driven by a buyer need. That is, a buyer states their need, and that stated need is matched with one or more sellers. The match can be electronically communicated to the one or more sellers, and the sellers can subsequently respond. The seller responses can then be electronically communicated to the buyer. The electronic communication can be made to the suppliers by, faxing, phoning, tweeting, a small message system (sms), an RDF site summary (RSS) feeds, an application programming interface (API) based integration, and/or third party integrations. Advantageously, the suppliers are provided with an opportunity that includes a buyer that is presently within a buying cycle. That is, the buyer is seeking a good or service that the supplier provides at the time the supplier receives the electronic introduction.

For another embodiment, a match is seller driven. That is, sellers indicate their capabilities and target customers. The matching engine then presents appropriate sellers to buyers based on the seller information and buyer information.

For other embodiments, the communication of buyer needs to sellers can include uploading the information on the buying opportunity to a website that is accessible by the selected set (additionally or alternatively, the website can be available to any supplier) of suppliers through, for example, the internet, phone applications and/or tablet applications. The selected set of suppliers can be directed to the website through various methods. For example, the suppliers can each be sent an email that includes a link to the website.

Embodiments include the company profile 118 being adaptively updated (by, for example, a commerce network server 111) as the company associated with the company profile 118 interacts with buyers 112, and/or suppliers 114. The company profile 118 can advantageously be used to generate a score for the company and/or match the company with other companies associated with the supplier/buyer commerce network 110. The company profile 118 is generally stored within a database associated with the supplier/buyer commerce network 110.

While the embodiments described are directed to a single company profile 118, it is to be understood that at least some of the described embodiments include multiple company profiles. For embodiments, each company profile corresponds with a different company associated with the supplier/buyer commerce network 110. The different company profiles provide a means for contrasting (for example, scoring) the different companies. Additionally, the different company profiles can be used to proactively match companies (suppliers 114 and buyers 112) associated with the supplier/buyer commerce network 110.

For embodiments, pieces of the self-reported information are used to drive additional processes in the supplier/buyer commerce network which can aid and supplement the matching. Initially, the self-reported information is typically focused on general company capabilities (commodities, company size, locations, revenues, etc.). However, the self-reported information can additionally include such things as target customer segments that, for example, a seller wants to sell to. Additionally, as will be described, a matching process engine can analyze commodities (goods & services) a supplier has selected as providing, and the sales territories of the supplier, in order to match that supplier's profile against the business opportunities.

The community information (quadrant B) includes information that pertains to the company that is provided by suppliers 114 and buyers 112 associated with the network. The community information includes, for example, ratings. The ratings allow, for example, a buyer to rate any supplier that has responded to a business opportunity on the supplier/buyer commerce network 110, which can be reflected in a company score the aids the matching.

The third party information (quadrant C) includes information that pertains to the company that is provided by a third party 170 about a buyer or seller. The third party information includes, for example, a business and credit rating provided by, for example, an established rating agency (such as, Dun & Bradstreet® (D&B)). The third party information can include financial risk information about suppliers. This can be provided, for example, using self-reported DUNS number information. The DUNS information can be validated with D&B using an API call. The validated information can be displayed back to the supplier for their approval. Once approved, the supplier/buyer commerce network basically has the supplier linked to a risk profile on D&B. Again, all of the third party information can be used to influence a company score that can be used to aid matching.

The aggregated activity information (quadrant D) includes, for example, transactional activity of the company. The aggregated activity information includes information about suppliers and their performance on the supplier/buyer commerce network 110.

A useful piece of aggregated activity information that is included within the company profile what commodity the company has either bought, sold, have or had a contract to buyer or sell. Additionally, the aggregated activity information can include the number of transacting relationships that the company has with buyers/suppliers 112, 114 on the supplier/buyer commerce network 110, and/or transacting relationships the company has with buyers/suppliers of other commerce networks, such as a cloud network. This information provides a valuable picture of how many other companies the company is actively doing business with via the supplier/buyer commerce network 110, and the cloud network. Other examples of aggregated activity information include, but are not limited to, event invitations, invitations by revenue, transaction awards (for example, winning supplier bids), revenue ranges, and/or top bids by industry.

The interface between the supplier/buyer commerce network 110 and cloud networks allows the supplier/buyer commerce network 110 to glean additional information that can be useful for enhancing the value of the company profile 118. For example, cloud networks can include sourcing and/or contract information and data. These embodiments determine commonality of suppliers/buyers across multiple private cloud networks. The different companies (buyer/sellers) are assigned unique identifiers by, for example, a unique ID engine, which allows the generation of a single view of the companies' behavior across multiple interactions (across the supplier/buyer commerce network 110 and the cloud networks). That is, for embodiments, one or more databases are associated with networks that maintain transactional activity of the company with other companies, and this transaction information for the company is identified by the unique identifier of the company. The unique ID engine can be operable, for example, on a server that is networked to the supplier/buyer commerce network 110.

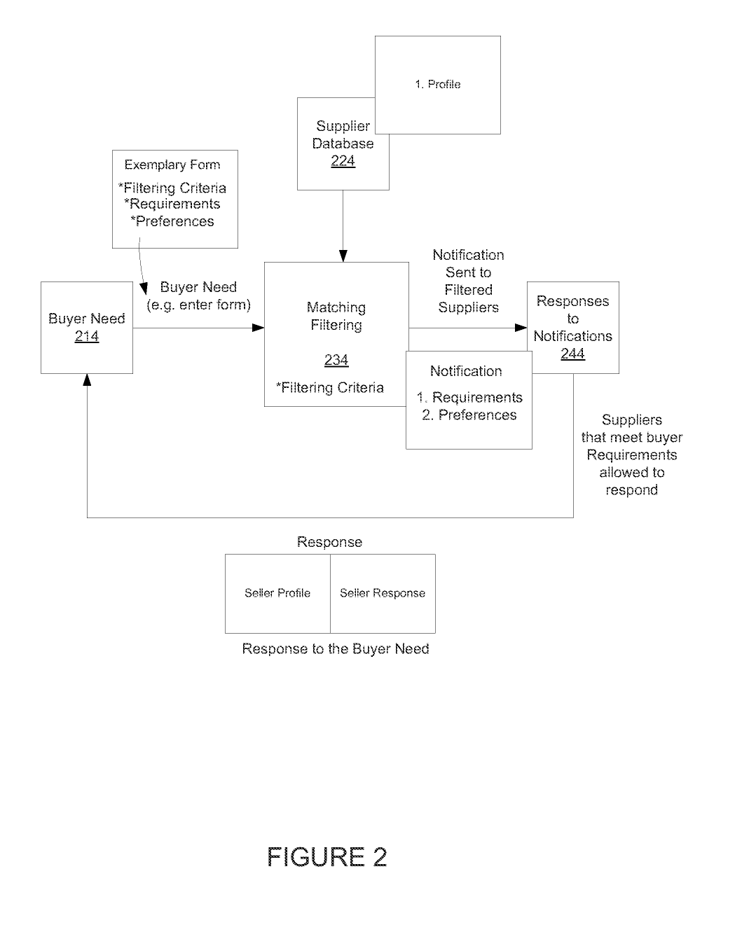

FIG. 2 shows is a block diagram that functionally shows a buyer being matched with one or more suppliers driven by the buyers need, according to an embodiment. A buyer need 214 is submitted by a buyer through, for example, a buyer-need form. Matching filtering 234 matches the buyer need 214 with supplier information of a supplier database (at this first step, matching is based on filtering criteria). For embodiments, the filtering only passes sellers that meet absolute filter criteria as set, for example, by the buyer need 214 (in this case, this is only for seller notifications). An embodiment of the seller database 224 includes seller profiles and the tracked seller behavior. For an embodiment, a notification is sent to the suppliers that meet the filtering requirements. A response to notification engine 244 allows the matched sellers that additionally meet buyer specified requirements (qualifications) to respond to the notification. For at least some embodiment, responses to the notification include answers to buyer-provided qualification questions and/or seller profile.

The buyer need 214 most importantly includes a commodity code (category of the good or serviced need) and location (where they want the good or service to be delivered) Additionally, the buyer need 214 may include filtering criteria and requirements that all responding sellers much meet, such as quality certifications, or business types (for example, the buyer may only want manufacturers to respond). The buyer need 214 may also include preferences (that is, characteristics) that the buyer would prefer, but are not exclusionary (such as diversity status, company size, etc.). The buyer need 214 may also include detailed information about what is needed, such as technical specifications, drawings, delivery requirements, location of manufacturing facility, brand requested, etc.

Embodiments of the matching filtering 234 include matching against commodity codes. For this embodiment, a hierarchical taxonomy is used to specify buyer needs. Based on the level of taxonomy selection (more general or more specific), matching algorithms may match more broadly (“up the commodity tree”). Matching to suppliers is based on the commodity code selected by the supplier and buyer. This matching filter precision may vary based on different parts of the “commodity tree” where a commodity tree density varies.

Embodiments of the matching filtering 234 occur with respect to location of the service or good to be delivered, either on a global, regional (e.g. North America), country, state, metropolitan or city level.

As shown, an embodiment of the supplier database 224 includes at least the profile of the supplier.

For at least some embodiments, the responses to notifications 244 are presented to buyers in some priority order. That prioritization can be based on an aggregated score, wherein the aggregated score is determined, for example, on a quality of the match, general supplier quality, bid price, date of response. As shown, an embodiment of the response includes the seller (supplier) profile and the seller's response.

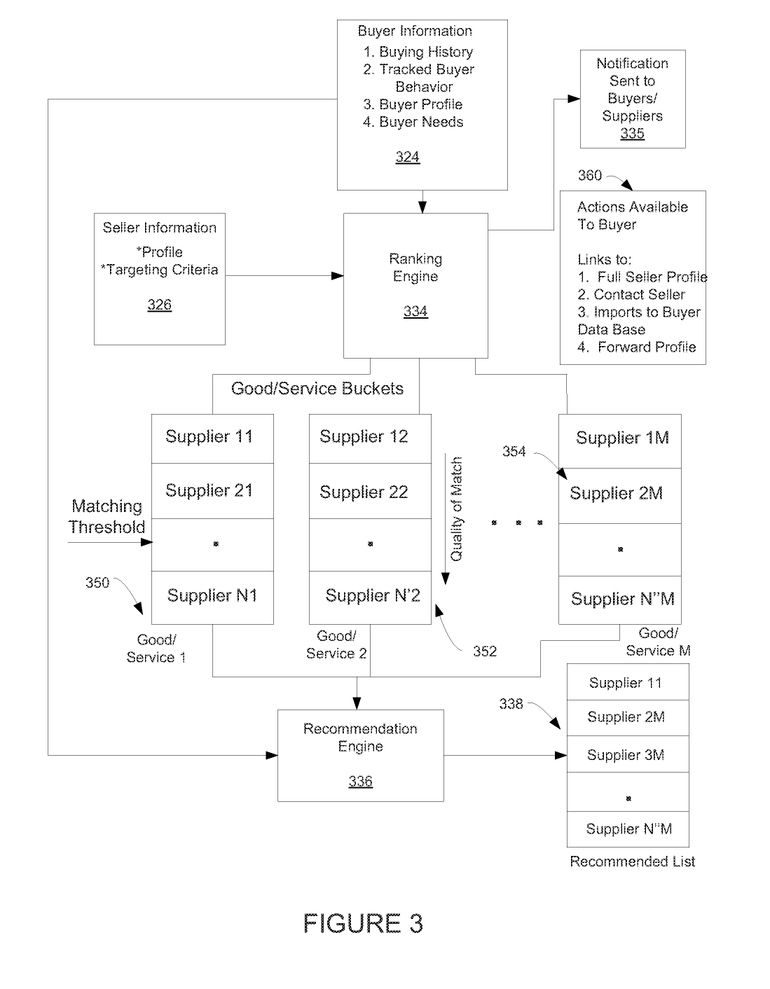

FIG. 3 shows is a block diagram that functionally shows a buyer being matched with one or more suppliers, driven by matching buyer and seller information, according to another embodiment. This embodiment includes a ranking engine 334 which ranks sellers (suppliers) based on, for example, the seller's selling history, the seller's profile, and targeting criteria. As shown, for this embodiment, the ranking engine receives at least buyer information 324 (for example, buyer history, tracked buyer behavior, the buyer profile, and/or buyer needs), and seller information 326 (for example, the seller profile and/or seller targeting criteria). For an embodiment, the ranking engine 334 generates one or more goods/services bucket 350, 352, 354. For an embodiment, the good/service buckets 350, 352, 354 are generated, wherein each good/service bucket 350, 352, 354 includes one or more suppliers that match the buyer need, wherein the buyer need includes at least one of a good or service that the buyer has indicated a present need. Within each good/service bucket 350, 352, 354, the suppliers are ordered according to the degree in which the supplier can match a buying need (that is, for example, an ability and/or capability to supply a particular good/service). That is, a supplier 1 within the good/server bucket 350 is determined by the ranking engine to be a better supplier than, for example, supplier N. Additionally, a ranking threshold can be set which sets the level of ranking of the supplier required in order to be a candidate for recommendation.

For at least some embodiments, the ranking is based on various parameters (for example, goods and/or services supplied, locations served, existing relationships with similar buyers based on industry or business type, number of buying relationships, annual revenue, etc) which can be tuned to recommend sellers who most actively match a buyer in a particular good or territory. Additionally the ranking engine 334 can be tuned to recommend sellers based on proficiency in a particular industry. For example, the ranking engine 334 can be tuned to favor (more highly rank) sellers who have supplied a service or good in a similar or related industry. Suppliers that are determined to be more proficient receive a higher ranking within the good/service buckets. For an embodiment, the ranking engine 334 notifies 335 one or more buyers and one or more suppliers of the good/service buckets. Further, actions 360 available to the buyer include, for example, links (which can be received through an electronic message) to a full seller profile, with or instructions for contacting a seller, to importation of a buyer database, for allowing the buyer to forward the buyer's profile.

An embodiment includes supplier targeting. For this embodiment, suppliers can set criteria by which they can be matched with a buyer (for example, industry of buyer, location, good/service history). In addition, a supplier may be able to present targeted information to each buyer that meets the targeting criteria (e.g. messages, product images, etc.). Further, the ranking engine 334 and the recommendation engine 336 can additional factor in the selling history (for example, how frequently the seller sells the good or service) of the sellers when creating the good/service buckets and the recommendation list.

An embodiment includes presenting suppliers in good/service buckets 350, 352, 354. Initially, the presentation may be a condensed set of information from the seller profile and targeted information, and “actions” the buyer can take with the seller (e.g. contact seller, see full seller profile, import seller into buyer's database). As shown and previously described, the actions 360 available to the buyer include, for example, links to a full seller profile, contact information of the seller, and/or imports to the buyer data base.

Once the good/service buckets that include ranked suppliers are created, a recommendation engine 336 generates a recommendation list 338 based on the good/service buckets 350, 352, 354, the buyer information 324 (such as, the buyer profile, buyer need, buying history, and/or tracked buyer behavior).

For an embodiment, one or more recommendation lists 338 are created and presented to buyers based on the buyer information 324, including the buyer need 337. The recommendation engine 336 creates ranked list of sellers from goods/services buckets and recommends sellers to buyers based on, for example, the frequency of selling of the seller, buying information, and buyer's behavior on past recommendations. Additionally, for an embodiment, the recommended lists 228 are created when a user of the buyer search for commodities. As described, for an embodiment the recommendation lists 338 are created based on the ranked good/service buckets 350, 352, 354. The recommendation engine 336 can also receive adhoc buying needs 337, and allow the adhoc buyer to search recommended sellers for good and services.

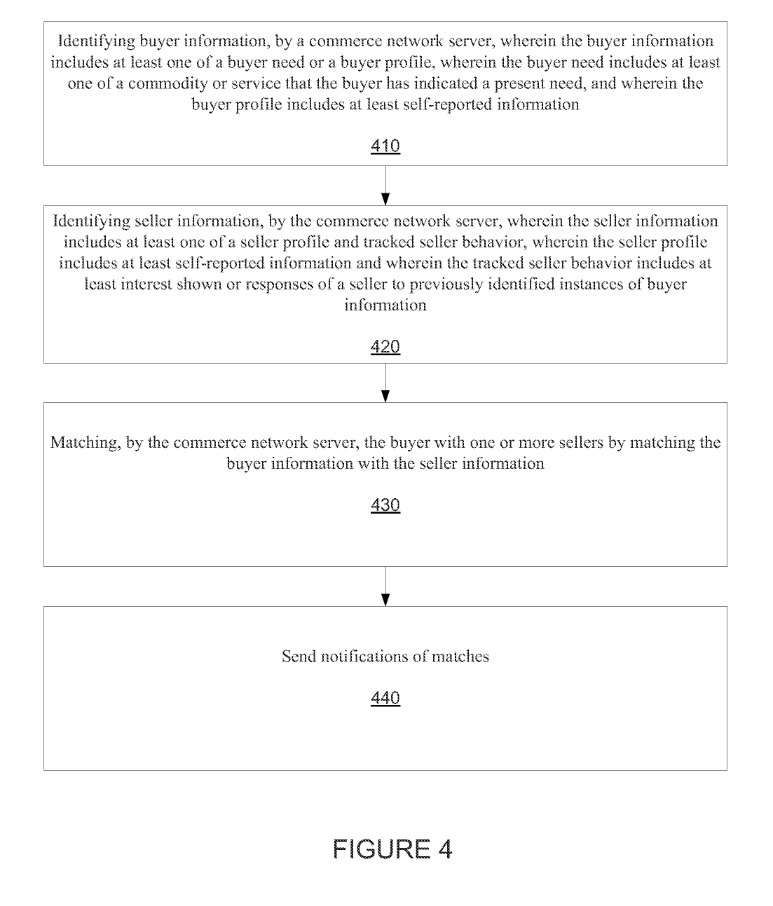

FIG. 4 is a flow chart that includes steps of a computer-method of a commerce network for matching buyers and sellers, according to an embodiment. A first step 410 includes identifying buyer information, by one or more commerce network servers, wherein the buyer information includes at least one of a buyer need or a buyer profile, wherein the buyer need includes at least one of a commodity or service that the buyer has indicated a present need, and wherein the buyer profile includes at least self-reported information. A second step 420 includes identifying seller information, by the one or more commerce network servers, wherein the seller information includes at least one of a seller profile and tracked seller behavior, wherein the seller profile includes at least self-reported information and wherein the tracked seller behavior includes at least interest shown or responses of a seller to previously identified instances of buyer information. A third step 430 includes matching, by the one or more commerce network servers, the buyers with sellers by matching the buyer information with the seller information. For at least some embodiments, the buyer need includes required buyer needs and preferred buyer needs. For at least one embodiment, the tracked seller behavior further includes seller preferences. An embodiment further includes presenting one or more matched buyers to the seller, or presenting one or more matched sellers to the buyer. For an embodiment, each buyer need includes multiple levels of commodity classifications.

For an embodiment, the buyer profile further includes community information, third party information, and aggregated activity information. For an embodiment, the aggregated activity information includes buyer activity information obtained by harvesting of buyer activity. For at least some embodiments, the seller profile further includes community information, third party information, and aggregated activity information.

An embodiment further includes receiving, by the one or more commerce network servers, the buyer need from the buyer, and generating, by the one or more commerce network servers, a buying need posting based on the buyer need, wherein the buying need posting includes a plurality of levels of classification for matching the buying need. For at least some embodiments, the levels for classification for matching include an absolute filter criteria (note that this can include inputs from both the buyer and the seller), buyer-specified requirements of good or service needed, buyer preferences on type or classification of sellers, or buyer-provided pre-qualifications.

For at least some embodiments, the buyer need includes at least one of a commodity, a location, a seller capability and required seller characteristics. For an embodiment, the seller capability includes capabilities directed to process used, quantity, product specifications etc. For at least some embodiments, the plurality of levels of classification include an absolute filter criteria, a requirement criteria, and a preferences criteria, wherein the absolute filter include criteria that the seller (assume per the seller profile) must meet in order to result in a match, the requirement criteria includes requirements a sellers response (to confirm the match) must include, and the preference criteria includes certain preferences desired by the buyer.

For at least some embodiments, matching the buying need includes matching the buyer need posting with one or more sellers, including filtering sellers of a seller database, wherein the filtering only passes sellers that meet absolute filter criteria, wherein the seller database includes seller profiles and the tracked seller behavior, and notifying the matched sellers. At least some embodiments further include allowing one or more of the matched sellers that additionally meet buyer specified requirements to respond to the notification. For at least some embodiment, responses to the notification include answers to buyer-provided pre-qualification questions.

At least some embodiments further include generating a plurality of recommendation buckets, wherein each recommendation bucket includes a ranked list of suppliers for one or more of a plurality of commodities and services. Further, at least some embodiments include allowing suppliers to set preferences on buyer types to be matched. That is, suppliers are allowed to set preferences on types of buyers, such as, industry, company size, etc. to be matched with, thereby allowing targeting outside of the company profiles. At least some embodiments further include generating a projection of buyer needs based on buyer activity information. At least some embodiments further include generating a summary distribution of the buyer activity that includes a real-time adaptive distribution of commodities and services purchased by the buyer. For at least some embodiments, matching comprises matching the buyer with one or more sellers, including matching the summary distribution of the buyer activity of the buyer with plurality of recommendation buckets, and notifying the matched sellers.

An embodiment includes notifying the one or more sellers of buying needs of the seller. An embodiment includes notifying one or more buyers of tracked seller behavior. For an embodiment, notifying includes sending an electronic message to one or more sellers associated with the commerce network, wherein the electronic message indicates to the one or more sellers, that the one or more sellers have been matched with a buyer need posting. For an embodiment, notifying comprises posting the buyer need posting on a website of the commerce network and receiving responses from sellers. An embodiment further includes the commerce network acquiring information about sellers who respond. For an embodiment, notifying comprises proactively providing to sellers through social media, and receiving responses from sellers. An embodiment further includes the commerce network acquiring information about sellers who respond.

An embodiment further includes the supplier/buyer commerce network electronically introducing buyer and suppliers. For an embodiment, this includes electronically harvesting information related to characteristics of at least one of the buyers. Further, the harvested information can be made anonymous. The anonymously harvested information can be presented to a selected set of the suppliers. Electronic introductions of interested suppliers to the at least one buyer can be facilitated. Finally, a formation of a business relationship between suppliers who express an interest and at least one buyer can be facilitated.

For an embodiment, the electronically harvested information includes commodity information, a response time-line, a product amount, and location information. Additionally, the harvested information can include information about the buyer which can be presented anonymously.

For an embodiment, electronically harvesting information includes maintaining a company profile of each of the buyers. For a specific embodiment, maintaining a company profile of each of the buyers associated with the supplier/buyer commerce network includes collecting activity information of the buyer. For an embodiment, collecting activity information of the buyer includes monitoring a plurality of databases that each maintains activity information associated with the buyer, assigning a unique identification for the company across the plurality of databases, exporting the activity information associated with the buyer from each of the plurality of databases, and aggregating the activity information. The company profile of the buyer is updated with the aggregated activity information of the company. For an embodiment, the company profile of the buyer further includes at least one of community information, self-reported information and third party information.

For an embodiment, anonymizing the harvested information includes redacting information within the harvested information that could be used to identify the buyer. For an embodiment, the harvested information in anonymized as selected by the buyer. The buyer can select the information to be minimally anonymous, or not anonymous at all.

Embodiments further include summarizing the harvested buyer information. This can include, for example, adding selected information. The added back information includes information about the buyer, for example, RFI/RFQ/Reverse Auction, Commodities, Location, Project Size, Industry, Revenue, State, employees, years in business, dollar amounts sourced on buyer/seller commerce network, typical commodities sourced. Additionally, it is to be understood that summarizing here can additionally include substituting information. For example, a buyer may be interested in buying beakers. The summarizing can include replacing the product term with a more generic term, such as, laboratory equipment. For non-anonymous versions, the buyer profile can be published. For embodiments, the added selected information is information associated with identification of a buying opportunity.

For an embodiment, selecting the set of suppliers includes identifying suppliers of goods or services that are similar to the goods or services desired by the at least one buyer, and/or identifying suppliers of goods or services that are located proximate to the at least one buyer.

For an embodiment, selecting the set of the suppliers includes maintaining a company profile of each of the suppliers, and identifying suppliers that match a company profile of the buyer. For an embodiment maintaining the company profile of each of the suppliers associated with the supplier/buyer commerce network includes collecting activity information of the supplier. For an embodiment, collecting activity information of the supplier includes monitoring a plurality of databases that each maintains activity information associated with the supplier, assigning a unique identification for the company across the plurality of databases, exporting the activity information associated with the buyer from each of the plurality of databases, and aggregating the activity information. The company profile of the supplier is updated with the aggregated activity information of the company.

As described, embodiments for presenting the anonymously harvested information to the selected set of the suppliers include electronically communicating the anonymously harvested information to each of the selected set of the suppliers. The electronic communication can be of one or more of many different forms, such as, emailing the anonymously harvested information to the selected set of suppliers. Other example of electronic communication include, but are not limited to, faxing, phoning, tweeting, sms messaging, RSS feeding, communicating through API based integration, and/or communicating through third party integrations.

As described, an embodiment for presenting the anonymously harvested information to a selected set of the suppliers, includes uploading the anonymously harvested information to a website that is accessible by the selected set of suppliers. The website can be accessed through one of many different means, such as, through the internet (web), through a mobile device, smart phone application and/or tablet applications.

As described, for an embodiment facilitating formation of a business relationship between suppliers who express an interest and the at least one buyer includes providing an electronic link to the buyer within an email. Clearly, the link can be communicated in other ways, such as, described above.

An embodiment includes aggregating the electronic introductions of buyers and suppliers. For an embodiment, the aggregating is based on certain attributes, and further includes presenting the harvested information. Examples of attributes include types of commodities, locations, industries, and/or project costing amounts. The publishing makes the aggregated data available, for example, to those who are doing industry research and/or benchmarking.

Embodiments include electronically communicating a buyer response digest to the buyer which includes the aggregated electronic introductions, providing a method for the buyer to respond to at least one of the aggregated electronic introductions. The digest provides a convenient way for the buyer to search, review and respond to one or more electronic introductions of an aggregation of electronic introductions received from the suppliers.

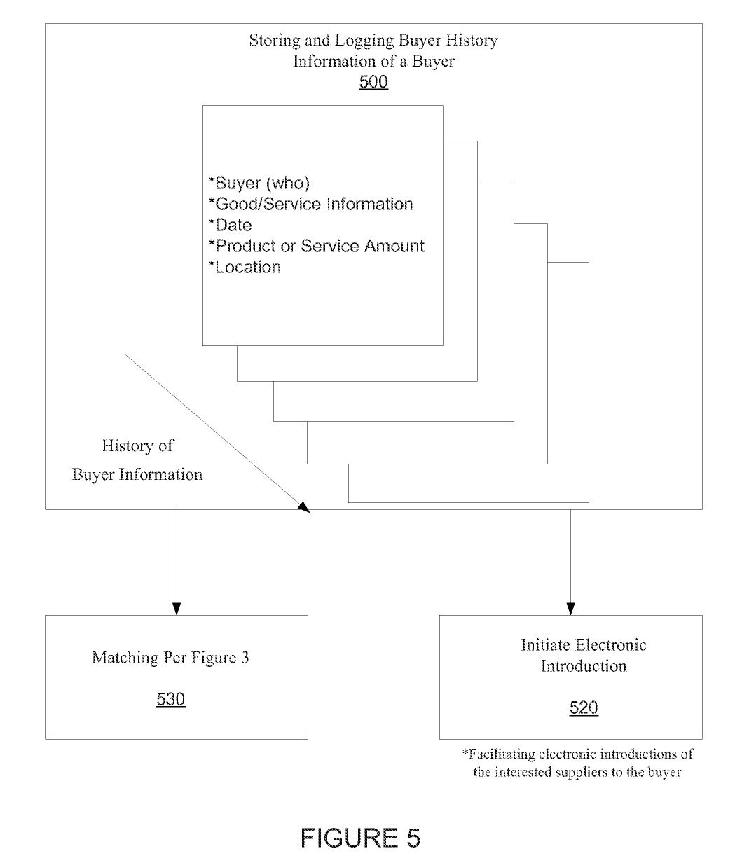

FIG. 5 illustrates storing and logging buyer history information according to an embodiment. An embodiment includes creating a database 500 of the buyer history information. The history of buyer information includes, for example, the buyer (that is, who the buyer is), commodity information (good/service), dates, and/or location of goods or services delivered. The database 500 allows suppliers to search and identify current and past records of buyer information that can be used for matching. That is, as shown in FIG. 5, current or past records of buyer information from the database 500 can be utilized, allowing suppliers to target buyers base on the past summarized buyer need records, which can lead to future electronic matching and introductions.

For an embodiment, the supplier/buyer commerce network includes matching functionality (530) that includes, for example, the functionality described in FIG. 3. Additionally, the supplier/buyer commerce network includes functionality (520) that allows the suppliers to initiate electronic introductions of interested suppliers to buyers, based on the summarized buyer need records of the electronic introduction database 500.

For embodiments, facilitating formation of a business relationship between suppliers who express an interest and the at least one buyer includes managing a collaborative exchange of information between the buyer and the at least one supplier, while maintaining the buyer anonymity for as long as the buyer desires. That is, the buyer can maintain a level of anonymity as far along in the collaborative information exchange as the buyer selects.

For other embodiments, facilitating formation of a business relationship between suppliers who express an interest and the at least one buyer includes interested suppliers electronically expressing interest in the buyer by submitting an introduction to a buyer's application, and the buyer at least one of electronically indicating no interest, electronically indicating a lack of present interest but indicating a chance of a future interest, or electronically indicating a present interest.

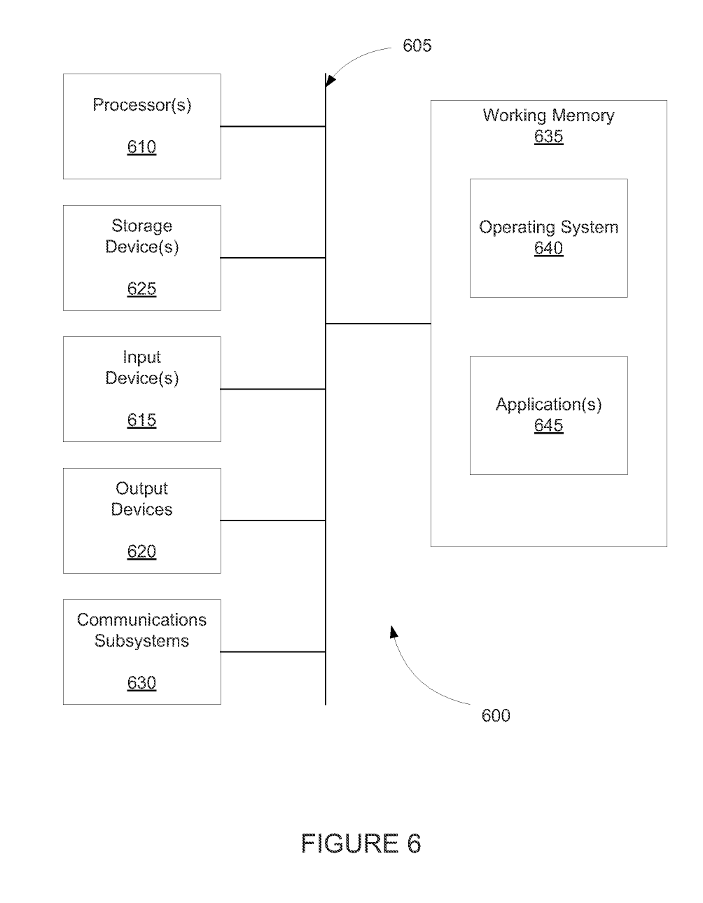

FIG. 6 shows a schematic illustration of one embodiment of a computer system that can perform the methods of the described embodiment, and/or can function as, for example, a commerce network for matching buyers and sellers. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements can include one or more processors 610, communication subsystems 630, one or more input devices 615, which can include without limitation a mouse, a keyboard and/or the like; and one or more output devices 620, which can include without limitation a display device, a printer and/or the like. The computer system 600 may further include (and/or be in communication with) one or more storage devices 625. The computer system 600 also can comprise software elements, shown as being located within the working memory 635, including an operating system 640 and/or other code, such as one or more application programs 645, which may comprise computer programs of the described embodiments, and/or may be designed to implement methods of the described embodiments and/or configure systems of the embodiments as described herein.

Another embodiment includes a program storage device readable by a machine (of the supplier/buyer commerce network), tangibly embodying a program of instructions executable by the machine to perform a method of a supplier/buyer commerce network electronically introducing buyers and suppliers. The method performed includes identifying buyer information, wherein the buyer information includes at least one of a buyer need or a buyer profile, wherein the buyer need includes at least one of a commodity or service that the buyer has indicated a present need, and wherein the buyer profile includes at least self-reported information, identifying seller information, wherein the seller information includes at least one of a seller profile and tracked seller behavior, wherein the seller profile includes at least self-reported information and wherein the tracked seller behavior includes at least interest shown or responses of a seller to previously identified instances of buyer information, and matching, the buyers with sellers by matching the buyer information with the seller information.

Although specific embodiments have been described and illustrated, the embodiments are not to be limited to the specific forms or arrangements of parts so described and illustrated.

What is claimed:

1. A computer-method of a commerce network for matching buyers and sellers, comprising:
identifying buyer information, by one or more commerce network servers, wherein the buyer information includes at least one of a buyer need or a buyer profile, wherein the buyer need includes at least one of a commodity or service that the buyer has indicated a present need, and wherein the buyer profile includes at least self-reported information;
identifying seller information, by the one or more commerce network servers, wherein the seller information includes at least one of a seller profile and tracked seller behavior, wherein the seller profile includes at least self-reported information and wherein the tracked seller behavior includes at least interest shown or responses of a seller to previously identified instances of buyer information; and
matching, by the one or more commerce network servers, the buyers with sellers by matching the buyer information with the seller information.

2. The method of claim 1, wherein the buyer need includes required buyer needs and preferred buyer needs.

3. The method of claim 1, wherein the tracked seller behavior further includes seller preferences.

4. The method of claim 1, wherein the buyer profile further includes community information, third party information, and aggregated activity information.

5. The method of claim 4, wherein the aggregated activity information includes buyer activity information obtained by harvesting of buyer activity.

6. The method of claim 1, wherein the seller profile further includes community information, third party information, and aggregated activity information.

7. The method of claim 1, further comprising presenting one or more matched buyers to the seller, or presenting one or more matched sellers to the buyer.

8. The method of claim 1, further comprising:
receiving, by the one or more commerce network servers, the buyer need from the buyer;
generating, by the one or more commerce network servers, a buying need posting based on the buyer need, wherein the buying need posting includes a plurality of levels of classification for matching the buying need.

9. The method of claim 8, wherein the buyer need comprises at least one of a commodity, a location, a seller capability and required seller characteristics.

10. The method of claim 8, wherein the plurality of levels of classification include an absolute filter criteria, a requirement criteria, and a preferences criteria, wherein the absolute filter include criteria that the seller must meet in order to result in a match, the requirement criteria includes requirements a sellers response must include, and the preference criteria includes certain preferences desired by the buyer.

11. The method of claim 8, wherein matching the buying need comprises:
matching the buyer need posting with one or more sellers, comprising filtering sellers of a seller database, wherein the filtering only passes sellers that meet absolute filter criteria, and wherein the seller database includes seller profiles and the tracked seller behavior; and
notifying the matched sellers.

12. The method of claim 11, further comprising:
allowing one or more of the matched sellers that additionally meet buyer specified requirements to respond to the notification.

13. The method of claim 12, wherein responses to the notification includes answers to buyer-provided pre-qualification questions.

14. The method of claim 1, wherein each buyer need includes multiple levels of commodity classifications.

15. The method of claim 1, further comprising:
generating a plurality of recommendation buckets, wherein each recommendation bucket includes a ranked list of suppliers for a one of a plurality of commodities and services.

16. The method of claim 15, further comprising allowing suppliers to set preferences on buyer types to be matched.

17. The method of claim 15, further comprising:
generating a projection of buyer needs based on buyer activity information.

18. The method of claim 17, further comprising generating a summary distribution of the buyer activity that includes a real-time adaptive distribution of commodities and services purchased by the buyer.

19. The method of claim 18, wherein matching comprises:
matching the buyer with one or more sellers, comprising matching the summary distribution of the buyer activity of the buyer with plurality of recommendation buckets; and
notifying the matched sellers.

20. The method of claim 1, further comprising notifying the one or more sellers of buying needs of the seller.

21. The method of claim 1, further comprising notifying one or more buyers of tracked seller behavior.

22. The method of claim 19, wherein notifying comprises sending an electronic message to one or more sellers associated with the commerce network, wherein the electronic message indicates to the one or more sellers, that the one or more sellers have been matched with a buyer need posting.

23. The method of claim 19, wherein notifying comprises posting the buyer need posting on a website of the commerce network and receiving responses from sellers.

24. The method of claim 19, wherein notifying comprises proactively providing to sellers through social media, and receiving responses from sellers.

25. A commerce network for matching buyers and sellers, comprising at least one commerce network server connected through a network to buyer servers and seller servers, the at least one commerce network server operative to:
identify buyer information, wherein the buyer information includes at least one of a buyer need or a buyer profile, wherein the buyer need includes at least one of a commodity or service that the buyer has indicated a present need, and wherein the buyer profile includes at least self-reported information;
identify seller information, wherein the seller information includes at least one of a seller profile and tracked seller behavior, wherein the seller profile includes at least self-reported information and wherein the tracked seller behavior includes at least interest shown or responses of a seller to previously identified instances of buyer information; and
match the buyer with one or more sellers by matching the buyer information with the seller information.

26. The commerce network of claim 25, wherein the at least one commerce network server is further operative to notifying the one or more sellers of buying needs of the seller.

27. The commerce network of claim 25, further comprising the at least one commerce network server further operative to:
receive the buyer need from the buyer;
generate a buying need posting based on the buyer need, wherein the buying need posting includes a plurality of levels of classification for matching the buying need.
match the buyer need posting with one or more sellers, comprising filtering sellers of a seller database, wherein the filtering only passes sellers that meet absolute filter criteria, and wherein the seller database includes seller profiles and the tracked seller behavior; and

28. The commerce network of claim 27, further comprising the at least one commerce network server further operative to:
allow one or more of the matched sellers that additionally meet buyer specified requirements to respond to the notification.

29. The commerce network of claim 28, wherein responses to the notification includes answers to buyer-provided pre-qualification questions.

30. The commerce network of claim 25, further comprising the at least one commerce network server further operative to:
generate a plurality of recommendation buckets, wherein each recommendation bucket includes a ranked list of suppliers for a one of a plurality of commodities and services.

31. The commerce network of claim 30, further comprising the at least one commerce network server further operative to:
generate a projection of buyer needs based on buyer activity information.

32. The commerce network of claim 31, further comprising the at least one commerce network server further operative to:
generate a summary distribution of the buyer activity that includes a real-time adaptive distribution of commodities and services purchased by the buyer.

33. The commerce network of claim 32, wherein that matching comprises:
matching the buyer with one or more sellers, comprising matching the summary distribution of the buyer activity of the buyer with plurality of recommendation buckets; and
notifying the matched sellers.
